(19) United States
(12) Patent Application Publication
(10) Pub. No.: US 2006/0171298 A1
(43) Pub. Date: Aug. 3, 2006

(54) Methods and systems for dynamic load balancing between call processors

(75) Inventor: Joe Quang Vu, Richardson, TX (US)

Correspondence Address: JENKINS, WILSON, TAYLOR & HUNT, P. A., 3100 TOWER BLVD, SUITE 1200, DURHAM, NC, 27707, US

(73) Assignee: Santera Systems, Inc.

(21) Appl. No.: 11/047,264

(22) Filed: Jan. 31, 2005

(51) Int. Cl. H04L 12/56; H04L 12/28; H04L 12/26; H04J 3/14; H04J 1/16; H04L 1/00

(52) U.S. Cl. 370/216; 370/229

(57) ABSTRACT

Methods and systems for dynamic load balancing between call processors are disclosed. The call processing load of each of the call processors is monitored in order to determine whether a call processing load balancing exists. In response to determining that a call processing load imbalance exists, call processing tasks relating to active calls are moved from at least a first call processor of the plurality of call processors to at least a second call processor of the plurality of call processors having a lower call processing load than the first call processor.

### TECHNICAL FIELD

The subject matter described herein relates to call processing and more particularly to dynamic load balancing call processing tasks between call processors.

### BACKGROUND

In modern telephony networks, media switching and call control functionality are separated. Media stream switching, which includes switching media packets between input and output ports and converting the media packets into the appropriate formats for the sending and receiving parties, is performed by a media gateway (MG). Call control, which includes setting up and tearing down calls and maintaining call state machines, is performed by a network entity commonly known as a media gateway controller (MGC), also referred to as a multiservice controller (MSC), call agent or call server. Media gateway controllers typically include a programmable network switch, known as a softswitch, that can process the control signaling of various packet protocols. Media gateway controllers communicate call control information to media gateways via a media gateway control protocol. Typical media gateway control protocols, such as MGCP and MEGACO, include commands for communicating information about each endpoint of a session to the media gateway and instructing the media gateway as to how to process packets to be delivered to each endpoint. The term “call processor” will be used generically herein to refer to any entity that processes and/or controls the setup and tear down of calls, such as the entities mentioned above.

For example, some of the functions of a call processor may include controlling connection services for a media gateway and/or other IP endpoints and maintaining corresponding call state information, selecting processes that can be applied to a call, providing routing for a call within the network based on signaling and customer database information, transferring control of the call to another network entity, and interfacing to and supporting management functions such as provisioning, fault, billing, etc.

In some high call traffic telephony applications, call processing tasks may be distributed among multiple call processor nodes. For example, some conventional methods may distribute new call processing tasks among multiple call processor nodes using a round robin load balancing algorithm. Although this technique may provide an initially balanced distribution of call processing tasks, the call processor nodes will eventually have an unbalanced load distribution because not all call processing tasks require the same duration of processing. For example, even though calls may be initially assigned to call processor nodes in an orderly manner, the calls will likely not be released from the call processor nodes in the same orderly manner.

FIG. 1 is a graphical representation of call processing tasks shared between three call processors 100, 102 and 104 using a round robin task assignment algorithm. In FIG. 1, CPs 100, 102 and 104 are each assigned call processing tasks according to graphs 106, 108 and 110, respectively. As can be appreciated from graphs 106, 108 and 110, using a conventional round robin distribution scheme, call processing tasks are added to each call processor 100, 102 and 104 at the same rate over time t. As can be appreciated from graphs 112, 114 and 116, for call processors 100, 102 and 104, tasks are ended at different rates over time. For example, the number of calls torn down in call processor 100, as illustrated by graph 112, may be much higher than the number of calls torn down in call processor 102, as illustrated by graph 114. As a result, one or more of CPs 100, 102 and 104 processes a larger share of the call processing tasks. This is illustrated in graphs 118, 120 and 122, which represent the net call processing tasks for CPs 100, 102 and 104, respectively. As shown, at time t₁, the number of call processing tasks for call processor 102, shown in graph 120, far exceeds the number of call processing tasks for call processors 100 and 104, shown in graphs 118 and 122, respectively. Conventional load balancing techniques failed to address the impact of the termination of call processing tasks, e.g., the tear down of calls. Consequently, call processing resources are not handled efficiently. For example, should call processor 102 fail or go offline for any reason, a disproportionately high number of calls will be dropped. Moreover, when a call processor is first placed online, it will have a disproportionately low number of calls in comparison to the other call processors.

Accordingly, a need exists for methods and systems for dynamic load balancing between call processors that consider the termination of call processing tasks.

### SUMMARY

In one aspect of the subject matter disclosed herein, a method for dynamic load balancing between call processors is disclosed. A call processing load of each of a plurality of call processors is determined and a call processing load imbalance between the plurality of call processors, if existing, is determined. In response to determining that a call processing load imbalance exists, call processing tasks relating to active calls are moved from at least a first call processor of the plurality of call processors to at least a second call processor of the plurality of call processors having a lower call processing load than the first call processor.

In another aspect of the subject matter disclosed herein, a system is disclosed for dynamic load balancing between call processors. The system includes a call processing load monitor for determining a call processing load of each of a plurality of call processors and for determining whether a call processing load imbalance exists between the plurality of call processors. The system also includes at least one active call migration manager for moving call processing tasks relating to active calls from at least a first call processor of the plurality of call processors to at least a second call processor of the plurality of call processors having a lower call processing load than the first call processor in response to the call processing load monitor determining that a call processing load imbalance exists.

In another aspect of the subject matter disclosed herein, a media gateway controller adapted for dynamic load balancing of call processing tasks relating to active calls includes a call processing load monitor for determining a call processing load of the media gateway controller and for determining whether a call processing load imbalance exists between the media gateway controller and other media gateway controllers. The media gateway controller also includes an active call migration manager for moving call processing tasks relating to active calls between the media gateway controller and at least one other media gateway controller in response to the call processing load monitor determining that a call processing load imbalance exists.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a graphical representation of call processing tasks shared between three call processors using a round robin task assignment algorithm;

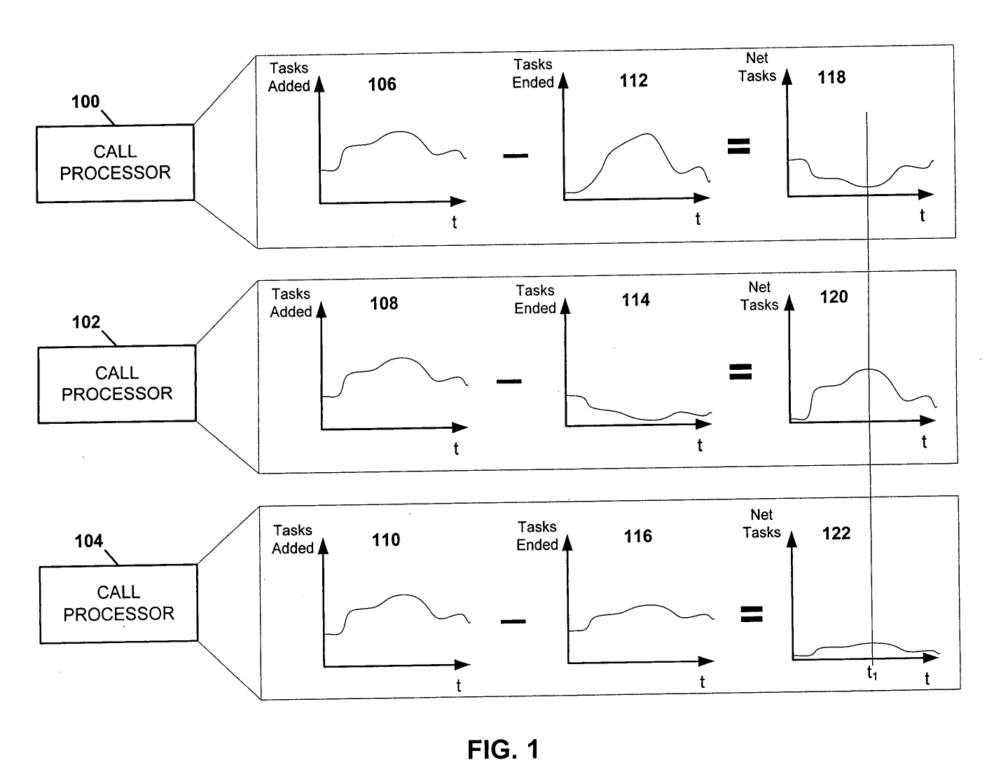

FIG. 2 is a block diagram illustrating a system for dynamic load balancing between call processors according to an aspect of the subject matter disclosed herein;

FIG. 3 is a block diagram illustrating a system for dynamic load balancing between call processors according to another aspect of the subject matter disclosed herein; and

FIG. 4 is a flow chart illustrating a method for dynamic load balancing between call processors according to an aspect of the subject matter disclosed herein.

### DETAILED DESCRIPTION OF THE INVENTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed. Any such form of embodiment can be referred to herein as “logic configured to” perform a described action, or alternatively as “logic that” performs a described action.

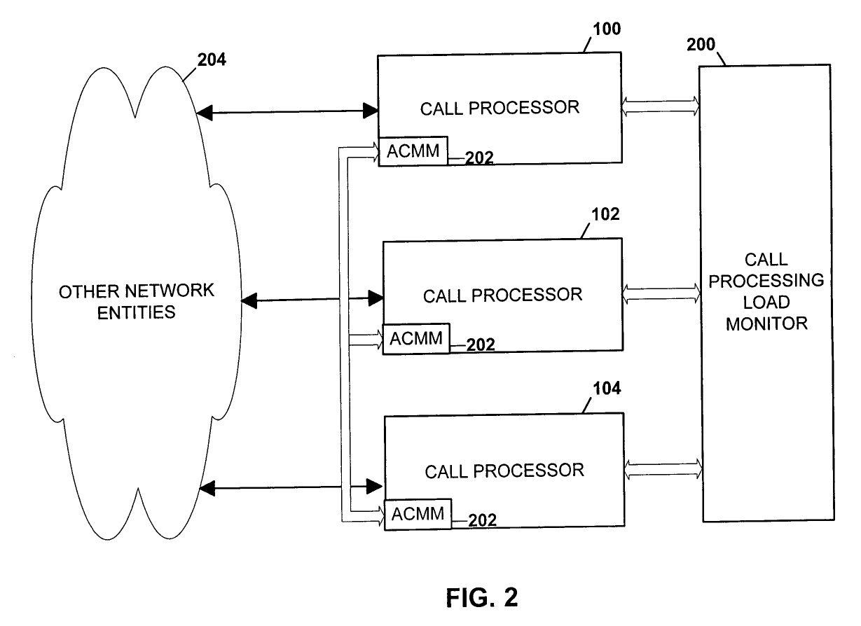

FIG. 2 is a block diagram illustrating a system for dynamic load balancing between call processors according to an aspect of the subject matter disclosed herein. In FIG. 2, call processors 100, 102 and 104 are monitored by a call processing load monitor 200. Call processing load monitor 200 includes logic configured to determine a call processing load of each call processor and determines whether a call processing load imbalance exists between the call processors. For example, call processing load monitor 200 may be implemented as an application running on a separate processing node or on one or more of call processors 100, 102 and 104. The term “call processing load” as used herein refers to a relation between a current call processing volume and a maximum or another user-specified threshold processing capacity of each call processor 100, 102 and 104.

The call processing load may be represented, for example, as a percentage or ratio and may take into account different processing capabilities, e.g., processing rates, of each call processor 100, 102 and 104. In one implementation, the call processing load is measured by call processing load monitor 200 determining the number of call instances at a call processor 100, 102 and 104. A call instance is information about a call maintained in the call processor for keeping track of calls. For example, the call instance can include information used to identify a call, such as a calling number, called number, dialed number, translated number, originating party, terminating party, originating time stamp, carrier identifier, originating resource, and/or terminating resource. The number of call instances can then be compared to the number of call instances allocated to the call processor 100, 102 and 104, since a call processor will typically pre-allocate all of its call instances in order to process incoming call attempts. In another implementation, the call processing load may be based on a processor usage percentage of one or more processors of a call processor. For example, a central processing unit (CPU) usage of a call processor can be obtained by call processing load monitor 200. In yet another implementation, call processing load monitor 200 maintains a respective counter for each call processor 100, 102 and 104 that keeps track of the number of active calls. For example, the counter for a call processor can be incremented each time a new call is added to the call processor and decremented each time a call is terminated. This number may be compared to a call threshold value corresponding to the call processor. Similarly, an overall data traffic rate or call rate of a call processor may be considered in determining a call processing load of a call processor. The call processing load of each call processor 100, 102 and 104 may be determined by call processing load monitor 200 at periodic intervals or at other times.

One or more of call processors 100, 102 and 104 also includes an active call migration manager (ACMM) 202. Active call migration managers 202 provide for the migration of call processing tasks from one call processor to another. The active call migration manager(s) 202 effectively move call processing tasks relating to active calls from one call processor to at least one other call processor having a lower call processing load. Call processing load monitor 200 may act as an intermediary between active call migration managers 202.

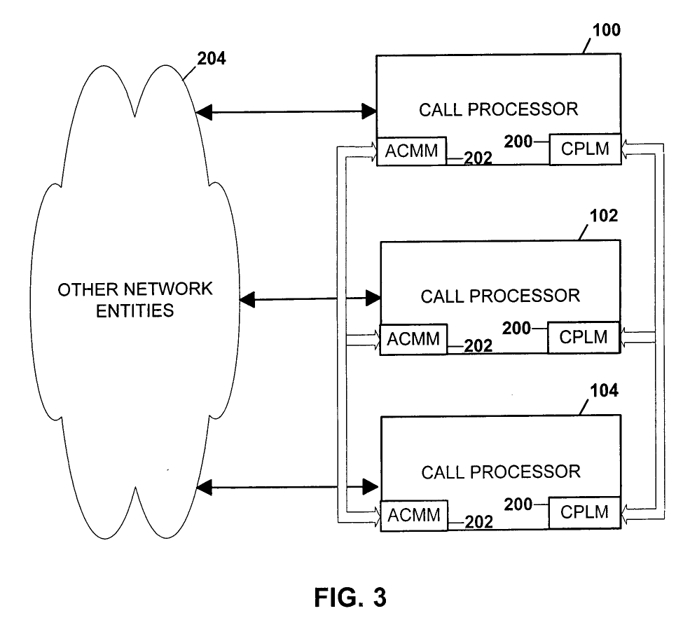

FIG. 3 is a block diagram illustrating a system for dynamic load balancing between call processors according to another aspect of the subject matter disclosed herein. In FIG. 3, call processing load monitor 200 is located in one or more of call processors 100, 102 and 104 for monitoring a call processing load of each of the call processors 100, 102 and 104. For example, each of call processors 100, 102 and 104 may include a call processing load monitor 200 and the different call processing load monitors 200 may share information to determine a call processing load of each of the call processors 100, 102 and 104 for comparison. Once again, call processing load monitor 200 may be one or more applications associated with call processors 100, 102 and 104.

In operation, call processing load monitor 200 monitors the call processing mode of call processors 100, 102 and 104. When call processing load monitor 200 determines that a call processing load imbalance exists between any two or more of call processors 100, 102 and 104, call processing load monitor 200 instructs one or more call processors to migrate active calls to one or more other call processors. For example, if a disproportionately high number of call processing tasks have been terminated at call processor 102, resulting in a higher number of call processing tasks related to active calls being processed at call processor 102 as compared to call processors 110 and/or 104, call processing load monitor 200 instructs call processor 102 to move call processing tasks, e.g., migrate active calls, to one or both of call processors 100 and 104. Active call migration managers 202 for the associated call processors begin moving call processing tasks from call processor 102 to call processor 100 and/or 104.

By way of example, assume that call processors 100, 102 and 104 have 4, 10 and 4 active calls, respectively, and that call processors 100, 102 and 104 each have a maximum processing capacity of 10 active calls. Call processing load manager 200 determines that call processors 100, 102 and 104 have call processing loads of, respectively, 4 active calls, 10 active calls and 4 active calls, or alternatively stated, call processing loads of 40%, 100% and 40%, respectively. Call processing load manager 200 may instruct call processor 102 to migrate calls to call processor 100 and/or call processor 104. For example, call processor 102 may be instructed to migrate 2 active calls to each of call processors 100 and 104, thus distributing the active calls such that each of call processors 100, 102 and 104 has 6 active calls. Alternatively, call processor 102 may be instructed to migrate 3 active calls to call processor 100 to distribute the active calls such that call processors 100 and 102 both have 7 active calls and 104 still has 4 active calls. As will be appreciated, several other distribution scenarios can be implemented.

According to one aspect, each active call migration manager 202 maintains a persistent data block (PDB) for each active call. The PDB is effectively an archive of all the data that is needed to re-create a call should a call processor fail. This data may be used, for the present purposes, to migrate calls from one call processor to another. A PDB is typically created once a call has entered a “stable state.” For example, a call can be considered to be in a stable state when a called party has answered the call, i.e., the call is in the ANSWERED state. A PDB can include at least some or all of the following data: a call identifier, a media gateway node identifier, an originating half-call state, a terminating half-call state, and call detail record (CDR) information for billing, such as a calling number, called number, dialed number, translated number, originating party, terminating party, originating time stamp, carrier identifier, originating resource, terminating resource, and the like.

When active calls are migrated from one call processor to another, a migrated-from active call migration manager 202 may forward a PDB for the calls to a migrated-to active call migration manager 202. Call processing load monitor 200 can act as an intermediary in transferring PDBs between active call migration managers 202. For example, call processing load monitor 200 may request the PDBs from the migrated-from active call migration manager 202 and forward them to the migrated-to active call migration manager 202. When a PDB transfer is completed, a call instance can be re-created using a received PDB on the migrated-to call processor and the corresponding call instance can be deleted at the migrated-from call processor.

Call processors 100, 102 and 104 also communicate with other network entities 204 to perform their associated call processing tasks. For example, call processors 100, 102 and 104 may be media gateway controllers that are in communication with other network entities 204, such as media gateways, call routers, and the like. Since only call instances are being transferred between call processors 100, 102 and 104, other networking entities 204, such as media gateways, need not be affected.

As discussed above, determining a call processing load of each of a plurality of call processors may include determining a call processing volume of the given call processor and comparing the call processing volume to a maximum call processing capacity of the given call processor. Determining the call processing volume of the given call processor may include counting a number of active calls or call instances and/or determining a data traffic rate associated with active calls. Moreover, determining a call processing volume of the given call processor may include determining an average call processing volume.

When determining a call processing load for a call processor, the specific processing capacity of the respective call processor may be considered. That is, different call processors may have different maximum call processing capacities that are based on a processing rate of each call processor. Call processors having a higher processing capacity may be assigned a larger number of call processing tasks than call processors having lower processing capacities, but will still have the same call processing load.

To determine whether a call processing load imbalance exists between call processors 100, 102 and 104, call processing load monitor 200 compares call processing loads of at least two of call processors 100, 102 and 104 and determines whether a call processing load imbalance exists based on the comparison. Here, one or more threshold values may be employed to avoid initiating call migration for minor load imbalances. For example, if a call processing load of call processor 100 is only 3% higher than a call processing load of call processor 102, it may not be beneficial to use system resources to migrate calls. That is, it may be more efficient to tolerate small call processing load differences between call processors 100, 102 and 104. In this way, unnecessary constant movement of call processing tasks for minor load imbalances that would otherwise result in a continuous oscillation can be avoided. Accordingly, using this approach, thresholds may be established for minimum call processing load imbalances such that small imbalances are tolerated as a tradeoff for conserving system resources.

In addition, in order to further balance the conservation of system resources for call migration, moving call processing tasks relating to active calls from one call processor to another can be based on whether a call processing load of the first call processor is above a minimum migration threshold. For example, the minimum migration threshold may be set at 10% capacity for a call processor. In such a case, only when the call processing volume for the call processor exceeds 10% will calls be migrated from the call processor to another call processor, even when a load imbalance exists. Using this approach, system resources are only used to move call processing tasks from a call processor when the call processor has a high enough call processing volume to merit concern should the call processor fail.

According to another aspect, call processing tasks relating to active calls are prevented from being moved too often. For example, call processing tasks associated with calls that have been moved before may be prevented from being moved again. Some identifying information may be associated with the call, i.e., the call may be flagged, to indicate that it has been migrated before. When active call migration manager 202 is preparing to migrate calls, flagged calls are not migrated. Alternatively, calls may be migrated more than once before being flagged.

According to yet another aspect, call processing tasks relating to calls that have been active for more than a threshold time duration may be disregarded in determining a call processing volume of a call processor. For example, if a call is nearing completion, according to a statistic average call duration, all call processing tasks associated with that call are not included in the call processing volume determination for that call processor. This approach conserves system resources that would be used for call migration by not considering calls that are nearing completion, and thus would lessen the call processing load of the call processor soon anyway, in the call processing volume determination. The duration threshold for determining when a call duration is far enough along to be ignored in call processing volume determinations may be set based on a statistical average duration of a call. For example, the average duration of a call may be determined statically by a network operator or dynamically and may be adjusted during operation of the call processor and the duration threshold may be gauged against this average duration. In one implementation, the duration threshold may be set at 50% the duration of an average call. In this case, calls having durations that are more than 50% the duration of an average call are ignored for call processing volume determination purposes. Alternatively, the duration threshold may be set at any percentage and may also be adjustable.

As an extension of the above-described implementation, active calls having a duration beyond the duration threshold may be prevented from being migrated to another call processor, since statistically the call will terminate soon anyway. Once again, this prevents the unnecessary use of system resources for migration.

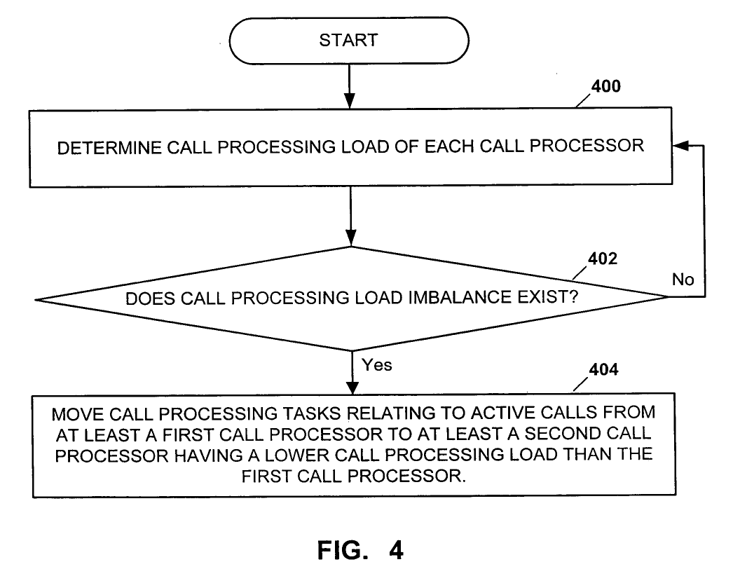

FIG. 4 is a flow chart illustrating a method for dynamic load balancing between call processors according to an aspect of the subject matter disclosed herein. In FIG. 4, a call processing load of each of a plurality of call processors is determined in step 400. In step 402, it is determined whether a call processing load imbalance exists between the plurality of call processors. In response to determining in step 402 that a call processing load imbalance exists, call processing tasks relating to active calls are moved from at least a first call processor to at least a second call processor having a lower call processing load than the first call processor in step 404. In response to determining in step 402 that a call processing load imbalance does not exist, control returns to step 400.

The systems and methods described herein provide dynamic load balancing between call processors that advantageously consider the effects of the termination of call processing tasks on call processing loads of call processors. Moreover, when a call processor is first placed online and has a disproportionately low number of calls in comparison to the other call processors, the call processing loads of the other call processors can be automatically shared.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for dynamic load balancing between call processors, the method comprising:
(a) determining a call processing load of each of a plurality of call processors;
(b) determining whether a call processing load imbalance exists between the plurality of call processors; and
(c) in response to determining that a call processing load imbalance exists, moving call processing tasks relating to active calls from at least a first call processor of the plurality of call processors to at least a second call processor of the plurality of call processors having a lower call processing load than the first call processor.

2. The method of claim 1 wherein the call processors comprise media gateway controllers.

3. The method of claim 1 wherein determining a call processing load of each of a plurality of call processors comprises, for a given call processor:
(a) determining a call processing volume of the given call processor; and
(b) comparing the call processing volume to a threshold call processing capacity of the given call processor.

4. The method of claim 3 wherein determining a call processing volume of the given call processor includes counting a number of call instances associated with the given call processor.

5. The method of claim 3 wherein determining a call processing volume of the given call processor includes determining a data traffic rate associated with active calls.

6. The method of claim 3 wherein determining a call processing volume of the given call processor includes determining a processor usage of a processor of the given call processor.

7. The method of claim 3 wherein determining a call processing volume of the given call processor includes determining an average call processing volume.

8. The method of claim 3 wherein determining a call processing volume of the given call processor includes determining the call processing volume of the given call processor based on call processing tasks relating to calls that have been in progress for less than a threshold time duration.

9. The method of claim 1 wherein at least some of the call processors have different threshold call processing capacities and wherein determining whether the call processing load balance exists includes comparing relative loadings of the call processors.

10. The method of claim 1 wherein determining whether a call processing load imbalance exists between the plurality of call processors comprises:
(a) comparing call processing loads of at least two call processors; and
(b) determining whether a call processing load imbalance exists based on the comparison.

11. The method of claim 10 wherein determining whether a call processing load imbalance exists based on the comparison includes determining whether a difference between call processing loads of the at least two call processors exceeds a threshold value.

12. The method of claim 1 wherein moving call processing tasks relating to active calls comprises:
(a) forwarding one or more persistent data blocks corresponding to active calls from the first call processor to the second call processor; and
(b) re-creating call instances at the second call processor based on the forwarded persistent data blocks.

13. The method of claim 1 wherein moving call processing tasks relating to active calls comprises moving call processing tasks relating to active calls from at least the first call processor to at least the second call processor based on whether a call processing load of the first call processor is above a minimum migration threshold.

14. The method of claim 1 wherein moving call processing tasks relating to active calls comprises moving call processing tasks relating to active calls from at least the first call processor to at least the second call processor based on whether the call processing tasks are related to active calls that have been moved before.

15. The method of claim 1 wherein moving call processing tasks relating to active calls comprises moving call processing tasks relating to active calls from at least the first call processor to at least the second call processor based on whether the call processing tasks are related to active calls that have been in progress for less than a threshold time duration.

16. The method of claim 1 wherein moving call processing tasks relating to active calls comprises moving call processing tasks from a first media gateway controller to at least one second media gateway controller without changing distribution of calls among the media gateways controlled by the media gateway controllers.

17. The method of claim 1 wherein moving call processing tasks relating to active calls includes moving the number of call processing tasks from the first call processor to at least the second call processor such that relative loading of the first and second call processors is substantially equal.

18. A system for dynamic load balancing between call processors, the system comprising:
(a) a call processing load monitor for determining a call processing load of each of a plurality of call processors and for determining whether a call processing load imbalance exists between the plurality of call processors; and
(b) at least one active call migration manager for moving call processing tasks relating to active calls from at least a first call processor of the plurality of call processors to at least a second call processor of the plurality of call processors having a lower call processing load than the first call processor in response to the call processing load monitor determining that a call processing load imbalance exists.

19. The system of claim 18 wherein the call processors comprise media gateway controllers.

20. The system of claim 18 wherein the call processing load monitor includes logic configured to determine a call processing load of each of a plurality of call processors comprises by:
(a) determining a call processing volume of the given call processor; and
(b) comparing the call processing volume to a maximum call processing capacity of the given call processor.

21. The system of claim 18 wherein the call processing load monitor includes logic configured to determine a call processing volume of the given call processor by counting a number of call processing tasks associated with active calls.

22. The system of claim 18 wherein the call processing load monitor includes logic configured to determine a call processing volume of the given call processor by determining a data traffic rate associated with active calls.

23. The system of claim 18 wherein the call processing load monitor includes logic configured to determine a call processing volume of the given call processor by determining an average call processing volume.

24. The system of claim 18 wherein the call processing load monitor includes logic configured to determine a call processing volume of the given call processor based on call processing tasks relating to calls that have been in progress for less than a threshold time duration.

25. The system of claim 20 wherein the call processing load monitor includes logic configured to determine a call processing volume of the given call processor by determining a processor usage of a processor of the given call processor.

26. The system of claim 18 wherein at least some of the call processors have different threshold call processing capacities and wherein determining whether the call processing load balance exists includes comparing relative loadings of the call processors.

27. The system of claim 18 wherein the call processing load monitor includes logic configured to determine whether a call processing load imbalance exists between the plurality of call processors by:
(a) comparing call processing loads of at least two call processors; and
(b) determining whether a call processing load imbalance exists based on the comparison.

28. The system of claim 27 wherein the call processing load monitor includes logic configured to determine whether a call processing load imbalance exists based on the comparison by determining if a difference between call processing loads of the at least two call processors exceeds a threshold value.

29. The system of claim 18 wherein the at least one active call migration manager includes logic configured to move call processing tasks relating to active calls from at least the first call processor to at least the second call processor by:
(a) forwarding one or more persistent data blocks corresponding to active calls from the first call processor to the second call processor; and
(b) re-creating call instances at the second call processor based on the forwarded persistent data blocks.

30. The system of claim 18 wherein the at least one active call migration manager includes logic configured to move call processing tasks relating to active calls from at least the first call processor to at least the second call processor based on whether a call processing load of the first call processor is above a minimum migration threshold.

31. The system of claim 18 wherein the at least one active call migration manager includes logic configured to move call processing tasks relating to active calls from at least the first call processor to at least the second call processor based on whether the call processing tasks are related to active calls that have been moved before.

32. The system of claim 18 wherein the at least one active call migration manager includes logic configured to move call processing tasks relating to active calls from at least the first call processor to at least the second call processor based on whether the call processing tasks are related to calls that have been in progress for less than a threshold time duration.

33. The system of claim 18 wherein the at least one active call migration manager includes logic configured to move call processing tasks relating to active calls from a first media gateway controller to at least one second media gateway controller without changing distribution of calls among the media gateways controlled by the media gateway controllers.

34. The system of claim 18 wherein the at least one active call migration manager includes logic configured to move call processing tasks relating to active calls from the first call processor to at least the second call processor such that relative loading of the first and second call processors is substantially equal.

35. A media gateway controller adapted for dynamic load balancing of call processing tasks relating to active calls, the media gateway controller comprising:
(a) a call processing load monitor for determining a call processing load of the media gateway controller and for determining whether a call processing load imbalance exists between the media gateway controller and other media gateway controllers; and
(b) an active call migration manager for moving call processing tasks relating to active calls between the media gateway controller and at least one of the other media gateway controllers in response to the call processing load monitor determining that a call processing load imbalance exists.
